(19) United States
(12) Patent Application Publication
(10) Pub. No.: US 2017/0188106 A1
(43) Pub. Date: Jun. 29, 2017

(54) Methods and systems for customizing a musical score of a media asset

(71) Applicant: Rovi Guides, Inc., Santa Clara, CA (US)

(72) Inventor: Reda Harb, Bellevue, WA (US)

(21) Appl. No.: 14/998,132

(22) Filed: Dec. 23, 2015

(51) Int. Cl. H04N 21/475; H04N 21/81; H04N 21/4627; H04N 21/439; H04N 21/4402; H04N 21/466; H04N 21/485; H04N 21/45

(52) U.S. Cl. CPC H04N 21/4755; H04N 21/4852; H04N 21/8113; H04N 21/4532; H04N 21/4394; H04N 21/44029; H04N 21/4667; H04N 21/4627; G10H 2210/021; G10H 2240/075; G10H 2240/131

(57) ABSTRACT

Methods and systems for customizing a musical score of a media asset. In some aspects, control circuitry receives a media asset including metadata and a video component, a foreground audio component, and/or a background audio component. The control circuitry generates for display the media asset. The control circuitry receives an instruction to replace a portion of the background audio component of the media asset being displayed. The control circuitry identifies an attribute for the portion of the background audio component from the metadata. The control circuitry retrieves a user preference relating to background audio. The control circuitry determines an audio asset based on the attribute and the user preference. The control circuitry retrieves the audio asset. The control circuitry modifies the media asset by replacing the portion of the background audio component with the audio asset. The control circuitry generates for display the modified media asset.

### BACKGROUND OF THE INVENTION

A musical score or background music is the music included in a television program or a feature film to serve and enhance the story. Every cue typically has a specific purpose, such as to intensify the suspense of a chase, enhance the emotional content of a conversation, or another suitable purpose. Cues are typically timed to begin and end at specific points during the television program or feature film. In conventional systems, viewers have no control over the musical score as the background music is part of the current scene and cannot be altered. The viewers cannot substitute other background music or turn off the background music if they so desire. As such, conventional systems lack the ability to offer a customized musical score suitable for the viewer.

### SUMMARY

Accordingly, methods and systems are disclosed herein for an interactive media guidance application, implemented on control circuitry of a user equipment device, that customizes a musical score or background music of a media asset. Unlike conventional systems, the interactive media guidance application allows a viewer to interact with the musical score or background music of a television program, a feature film, or another suitable media asset. For example, the viewer may select an alternative musical score for the media asset currently being displayed. In another example, the viewer may select to mute the background music for the media asset currently being displayed. In yet another example, the viewer may select to add background music where there is no background music in the media asset currently being displayed. In yet another example, the viewer may select alternative musical scores, add musical scores where there is no background music, or mute the background music for one or more portions of the media asset.

In some embodiments, the interactive media guidance application selects an alternative musical score for the media asset currently being displayed based on a user preference. The media asset includes associated metadata for a video component, a foreground audio component, and/or a background audio component. For example, the video component may represent the video frames of the media asset, the foreground audio component may represent the dialogue, special effects, and other suitable audio, and the background audio component may represent the musical score or background music. The interactive media guidance application identifies an attribute for the background audio component currently being used to generate the display of the media asset. For example, the interactive media guidance application may identify an attribute for the background audio component such as an artist, a track title, an album title, a tempo, a pitch, an intensity or loudness, or another suitable attribute.

The interactive media guidance application identifies a user preference attribute from the user preference. The user preference attribute is representative of the audiovisual history of the viewer. For example, the user preference attribute may include such an artist, a track title, an album title, a tempo, a pitch, an intensity or loudness, or another suitable attribute for audio and video media assets consumed by the viewer in the past. The interactive media guidance application compares the background audio attribute and the user preference attribute and may find that they do not match. This means that the viewer does not have a preference for the background music currently being played in the media asset.

For example, the user preference attribute may indicate the viewer has a preference for tempo in a given range. The background music attribute may indicate tempo in a range outside other of the viewer's preferred range. In this example, the interactive media guidance application determines that the current portion of the background audio component of the media asset needs to be replaced with another audio asset suitable for the viewer. The suitable audio asset is selected based on the user preference attribute. The interactive media guidance application may trim a play time of the selected audio asset to match the play time of the portion of the background audio component being replaced.

In some embodiments, the interactive media guidance application replaces the background audio component of a media asset with the background audio component of another media asset. For example, the interactive media guidance application may substitute the musical score of a movie, such as “Transformers: Age of Extinction,” with the musical score of another related movie, such as “Inception.” These musical scores are related in this example because they are composed by the same person and the movie studio is licensed to use both musical scores. In some embodiments, the viewer receives an option to select an alternative musical score when selecting a media asset for display.

For example, the viewer may receive a pop-up to select the musical score from “Inception” when selecting to view the movie “Transformers: Age of Extinction.” The selection of the musical score from “Inception” may provide an alterative metadata file that may be used to generate for display the media asset. The metadata file may include references to scenes or blocks of frames and the background music that should be substituted instead of the original background music provided for the media asset. For example, the metadata file may include SMPTE timecodes. The SMPTE timecodes are a form of media metadata and can be used to label individual frames of video with a time code to synchronize music.

In another example, the viewer may receive a pop-up to select from different musical scores relating to different themes, such as exciting, somber, or another suitable theme. Each theme corresponds to a different metadata file that is provided for use when generating for display the media asset. In yet another example, the media asset does not include a background audio component or related metadata and instead receives the background audio component and related metadata when the user selects a suitable theme for the media asset.

In some embodiments, the interactive media guidance application selects an alternative musical score from the viewer's personal music library. Since the viewer has purchased the music in his or her library, using one or more audio assets as background music may be an acceptable use for the purchased audio assets. The audio assets may be associated with digital rights permissions specifying whether the viewer may use them as background music in a customized media asset. The interactive media guidance application may only use audio assets from the viewer's personal music library if the digital rights permissions for the audio assets allow use as background music for the viewer's customized media asset.

In some aspects, the methods and systems described herein provide for customizing a musical score of a media asset. An interactive media guidance application is implemented on control circuitry of a user equipment device. The interactive media guidance application receives a media asset including metadata and at least one of a video component, a foreground audio component, and a background audio component. In some embodiments, the metadata is received separately from the media asset. In some embodiments, the metadata comprises separate metadata files for each of the video component, the foreground audio component, and the background audio component. The interactive media guidance application generates for display the media asset.

The interactive media guidance application receives an instruction to replace a portion of the background audio component of the media asset being displayed. In some embodiments, the instruction to replace the portion of the background audio component of the media asset being displayed is received from a user. In some embodiments, the instruction to replace the portion of the background audio component of the media asset being displayed is automatically generated based on the user preference relating to background audio. For example, the user or the interactive media guidance application may select an alternative musical score for the media asset currently being displayed. In another example, the user or the interactive media guidance application may select to mute the background music for the media asset currently being displayed. In yet another example, the user or the interactive media guidance application may select to add background music where there is no background music in the media asset currently being displayed.

The interactive media guidance application identifies an attribute for the portion of the background audio component from the metadata. For example, the interactive media guidance application may identify an attribute for the background audio component such as an artist, a track title, an album title, a tempo, a pitch, an intensity or loudness, or another suitable attribute. The interactive media guidance application retrieves a user preference relating to background audio from a memory. The interactive media guidance application identifies a user preference attribute from the user preference. In some embodiments, the user preference relating to the background audio comprises a user preference attribute based on an audiovisual history of a user. For example, the user preference attribute may include such an artist, a track title, an album title, a tempo, a pitch, an intensity or loudness, or another suitable attribute for audio and video media assets consumed by the user in the past.

The interactive media guidance application determines an audio asset based on the identified attribute and the retrieved user preference. For example, the interactive media guidance application may compare the background audio attribute and the user preference attribute and may find that they do not match. This means that the user does not have a preference for the background music currently being played in the media asset. In this example, the interactive media guidance application determines that the current portion of the background audio component of the media asset needs to be replaced with another audio asset suitable for the user. The suitable audio asset may be selected based on the user preference attribute.

The interactive media guidance application retrieves the determined audio asset from the memory. The interactive media guidance application modifies the media asset by replacing the portion of the background audio component of the media asset with the determined audio asset. In some embodiments, the interactive media guidance application, modifying the media asset by replacing the portion of the background audio component of the media asset with the determined audio asset, further includes trimming a play time of the determined audio asset to substantially match a play time of the portion of the background audio component. The interactive media guidance application generates for display the modified media asset.

In some embodiments, the interactive media guidance application, determining the audio asset based on the identified attribute and the retrieved user preference, includes the interactive media guidance application determining whether the identified attribute corresponds to the user preference attribute. For example, the user preference attribute may indicate the user has a preference for tempo in a given range. The background music attribute may indicate tempo in a range outside other of the user's preferred range. In response to determining that the identified attribute does not correspond to the user preference attribute, the interactive media guidance application determines the audio asset based on the user preference attribute. In some embodiments, in response to determining that the identified attribute corresponds to the user preference attribute, the interactive media guidance application selects the portion of the background audio component.

In some embodiments, the interactive media guidance application, determining the audio asset based on the identified attribute and the retrieved user preference, includes the interactive media guidance application identifying the audio asset relating to the identified attribute and the retrieved user preference. The interactive media guidance application retrieves digital rights permissions for the audio asset from the memory. The interactive media guidance application selects the audio asset if the digital rights permissions allow use as background music. For example, the interactive media guidance application may only use audio assets if the digital rights permissions for the audio assets allow use as background music for the user's customized media asset. In some embodiments, the determined audio asset is retrieved from a music library for a user. Since the user has purchased the music in his or her library, using one or more audio assets as background music may be an acceptable use for the purchased audio assets.

It should be noted that the systems, methods, apparatuses, and/or aspects described above may be applied to, or used in accordance with, other systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for determining an audio asset to replace a portion of the background audio component of a media asset in accordance with some embodiments of the disclosure;

FIG. 6 is pseudocode of illustrative steps for determining an audio asset to replace a portion of the background audio component of a media asset in accordance with some embodiments of the disclosure;

FIG. 7 is a diagram of a display relating to customizing the musical score of a media asset in accordance with some embodiments of the disclosure;

FIG. 8 is a diagram of another display relating to customizing the musical score of a media asset in accordance with some embodiments of the disclosure;

FIG. 9 is a diagram of yet another display relating to customizing the musical score of a media asset in accordance with some embodiments of the disclosure;

FIG. 10 is a flowchart of an illustrative process for customizing the musical score of a media asset in accordance with some embodiments of the disclosure; and

FIG. 11 is illustrative metadata for a media asset in accordance with some embodiments of the disclosure.

### DETAILED DESCRIPTION

Methods and systems for customizing a musical score of a media asset are described. In some aspects, control circuitry receives a media asset including metadata and a video component, a foreground audio component, and/or a background audio component. The control circuitry generates for display the media asset. The control circuitry receives an instruction to replace a portion of the background audio component of the media asset being displayed. The control circuitry identifies an attribute for the portion of the background audio component from the metadata. The control circuitry retrieves a user preference relating to background audio. The control circuitry determines an audio asset based on the attribute and the user preference. The control circuitry retrieves the audio asset. The control circuitry modifies the media asset by replacing the portion of the background audio component of the media asset with the audio asset. The control circuitry generates for display the modified media asset.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

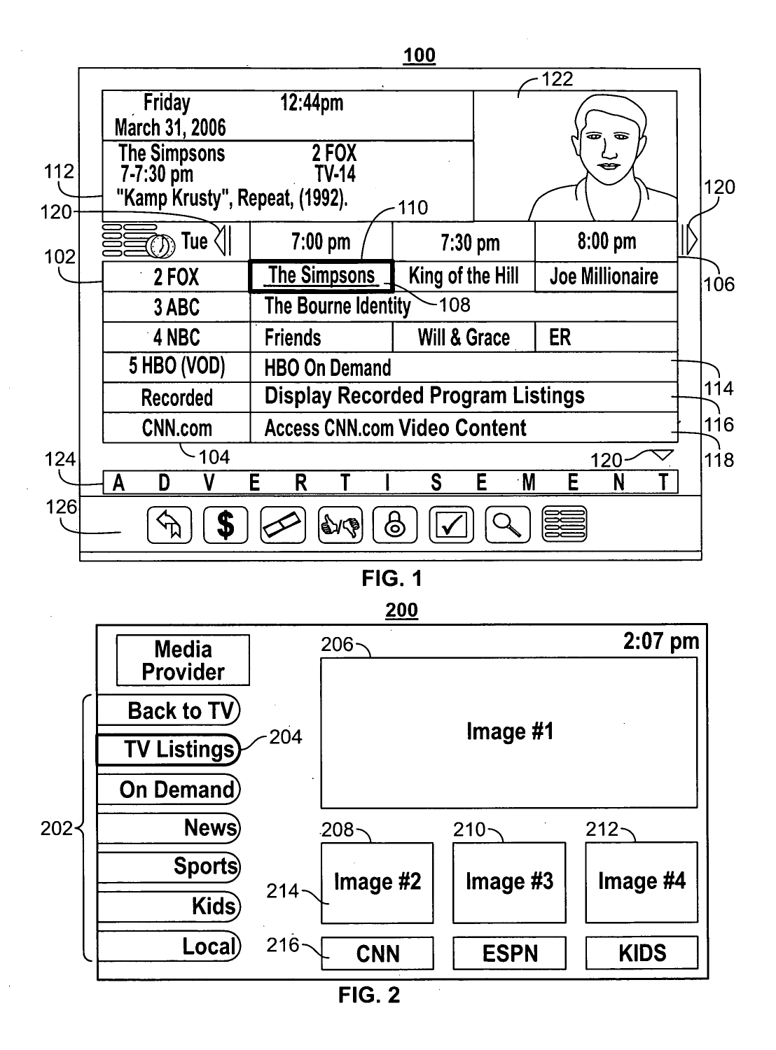

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of tithe identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

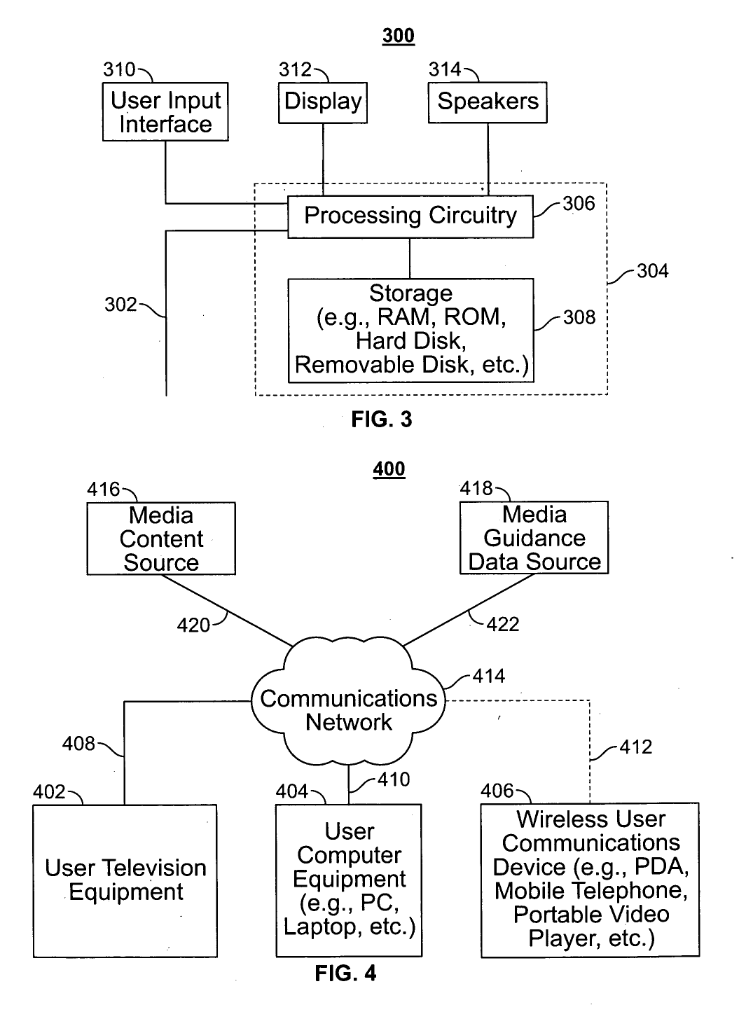

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has' increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

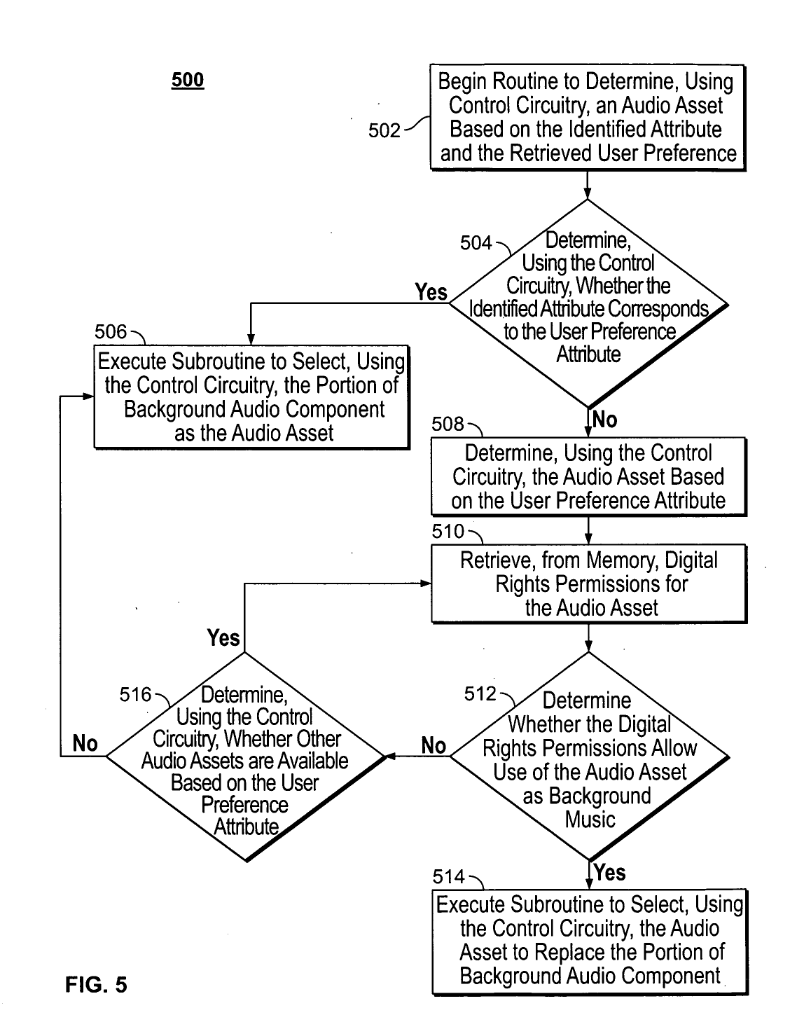

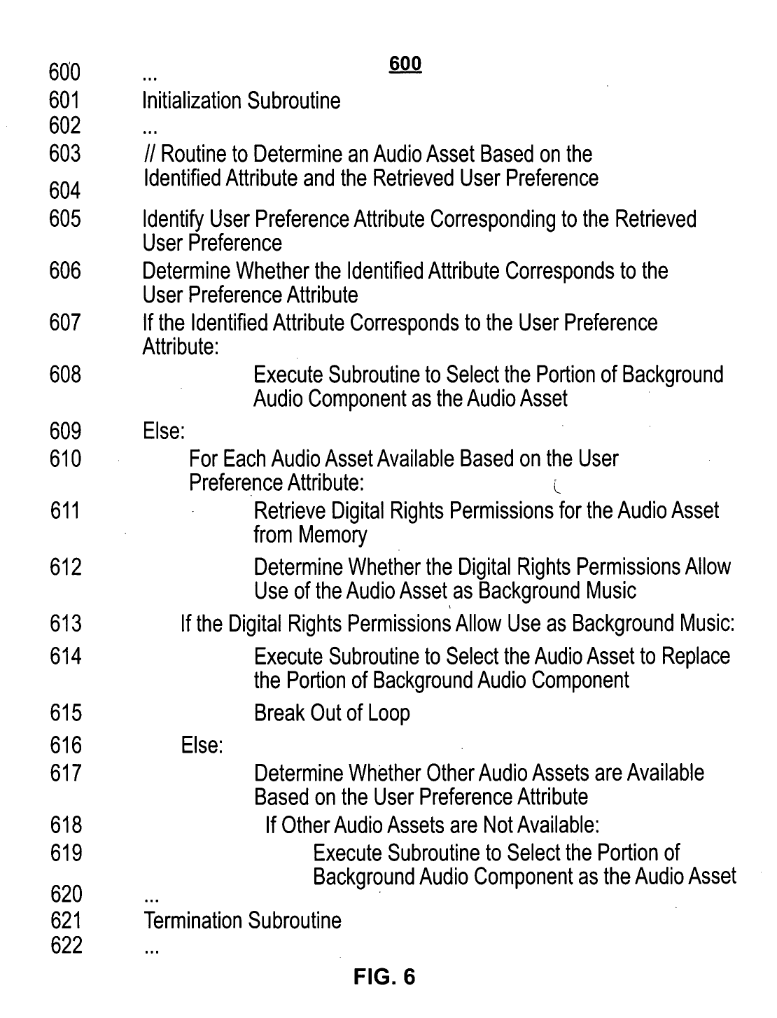

FIGS. 5 and 6 present an algorithm for control circuitry (e.g., control circuitry 304) to determine an audio asset to replace a portion of the background audio component of a media asset in accordance with some embodiments of the disclosure. In some embodiments this algorithm may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 5 describes a process implemented on control circuitry (e.g., control circuitry 304) to determine an audio asset to replace a portion of the background audio component of a media asset in accordance with some embodiments of the disclosure.

At step 502, control circuitry 304 begins a routine to determine an audio asset based on the attribute identified from a background audio component of a media asset and a retrieved user preference. In some embodiments, this may be done either directly or indirectly in response to a user action or input (e.g., from signals received by control circuitry 304 or user input interface 310). For example, the process may begin directly in response to control circuitry 304 receiving signals from user input interface 310, or control circuitry 304 may prompt the user to confirm their input using a display (e.g., by generating a prompt to be displayed on display 312) prior to running the algorithm.

Control circuitry 304 retrieves a user preference attribute for the user preference from memory. In some embodiments, control circuitry 304 may receive a single primitive data structure that represents the value of the storage required for the media asset. In some embodiments, the value may be stored as part of a larger data structure, and control circuitry 304 may retrieve the value by executing appropriate accessor methods to retrieve the value from the larger data structure.

At step 504, control circuitry 304 proceeds to determine whether the identified attribute corresponds to the user preference attribute. For example, the user preference attribute may indicate the user has a preference for tempo in a given range. The background music attribute may indicate tempo in a range outside other of the viewer's preferred range. In some embodiments, the identified attribute may be stored (e.g., on storage device 308) prior to beginning the process. In some embodiments, control circuitry 304 may directly compare the identified attribute to the user preference attribute by accessing the values respectively from memory and performing a value comparison. In some instances, control circuitry 304 may call a comparison function (e.g., for object to object comparison) to compare identified attribute and the user preference attribute. If the condition is satisfied, control circuitry 304 proceeds to step 506; if the condition is not satisfied, control circuitry 304 proceeds to step 508 instead.

At step 506, control circuitry 304 executes a subroutine to select the portion of the background audio component as the audio asset. This means that the portion of the background audio component need not be replaced with an alternative audio asset because the portion of the background audio component is compliant with the user preference and the user preference attribute. In some embodiments, control circuitry 304 stops the process and returns a message that the media asset need not be modified with a replacement audio asset. In some embodiments, control circuitry 304 proceeds through the steps for replacing the portion of the background audio component if required.

At step 508, control circuitry 304 executes a subroutine to determine an audio asset based on the user preference attribute. In some embodiments, the control circuitry 304 selects an alternative musical score from the user's personal music library. Control circuitry 304 may only use audio assets from the user's personal music library if the digital rights permissions for the audio assets allow use as background music for the user's customized media asset.

At step 510, control circuitry 304 retrieves the digital rights permissions for the audio asset from memory. The digital rights permissions may be stored in a database or as a separate file for the audio asset. The audio asset may be associated with digital rights permissions specifying whether the user may use the audio asset as background music in a customized media asset. At step 512, control circuitry determines whether the digital rights permissions allow use of the audio asset as background music in a customized media asset. If the condition is satisfied, control circuitry 304 proceeds to step 514; if the condition is not satisfied, control circuitry 304 proceeds to step 516 instead.

At step 514, control circuitry 304 executes a subroutine to select the audio asset to replace the portion of the background audio component of the media asset. This means that the portion of the background audio component is to be replaced with the alternative audio asset because the portion of the background audio component is not compliant with the user preference and the user preference attribute. In some embodiments, control circuitry 304 stops the process and returns a message that the media asset is to be modified with a replacement audio asset. In some embodiments, control circuitry 304 proceeds through the steps for replacing the portion of the background audio component if required.

At step 516, control circuitry 304 determines whether other audio assets are available based on the user preference attribute. For example, control circuitry 304 may call a function to determine whether other audio assets are available based on the user preference attribute. If the function returns true (i.e., there are still instances that need to be processed), control circuitry 304 may proceed to step 510. If all other audio assets have been evaluated, control circuitry 304 proceeds to step 506. This means that no audio asset based on the user preference attribute is available to replace the portion of the background audio component.

It is contemplated that the descriptions of FIG. 5 may be used with any other embodiment of this disclosure. In addition, the descriptions described in relation to the algorithm of FIG. 5 may be done in alternative orders or in parallel to further the purposes of this disclosure. For example, conditional statements and logical evaluations may be performed in any order or in parallel or simultaneously to reduce lag or increase the speed of the system or method. As a further example, in some embodiments several instances of available audio assets may be evaluated in parallel, using multiple logical processor threads or the algorithm may be enhanced by incorporating branch prediction. Furthermore, it should be noted that the process of FIG. 5 may be implemented on a combination of appropriately configured software and hardware, and that any of the devices or equipment discussed in relation to FIGS. 3-4 could be used to implement one or more portions of the process.

The pseudocode in FIG. 6 describes a process to determine an audio asset to replace a portion of the background audio component of a media asset in accordance with some embodiments of the disclosure. It will be evident to one skilled in the art that the process described by the pseudocode in FIG. 6 may be implemented in any number of programming languages and a variety of different hardware, and that the style and format should not be construed as limiting, but rather a general template of the steps and procedures that would be consistent with code used to implement some embodiments of this disclosure.

At line 601, control circuitry 304 runs a subroutine to initialize variables and prepare to determine an audio asset to replace a portion of the background audio component of a media asset, which begins on line 605. For example, in some embodiments, control circuitry 304 may copy instructions from non-transitory storage medium (e.g., storage device 308) into RAM or into the cache for processing circuitry 306 during the initialization stage. Additionally, in some embodiments the attribute identified from the background audio component being used for comparison, or a tolerance level for determining if two values are essentially equivalent, may be retrieved, set, and stored at 601.

At line 605, control circuitry 304 identifies a user preference attribute corresponding to the retrieved user preference. In some embodiments, these instances may be retrieved from memory. Control circuitry 304 may receive the user preference attribute by receiving, for example, a pointer to an array for multiple user preferences. In another example, control circuitry 304 may receive an object of a class, such as an iterator object containing elements for multiple user preferences.

At line 606, control circuitry 304 determines whether the identified attribute corresponds to the user preference attribute. For example, the user preference attribute may indicate the user has a preference for tempo in a given range. The background music attribute may indicate tempo in a range outside other of the viewer's preferred range. In some embodiments, the identified attribute may be stored (e.g., on storage device 308) prior to beginning the process. In some embodiments, control circuitry 304 may directly compare the identified attribute to the user preference attribute by accessing the values respectively from memory and performing a value comparison. In some instances, control circuitry 304 may call a comparison function (e.g., for object to object comparison) to compare identified attribute and the user preference attribute. At line 607, control circuitry checks the result of the condition in line 606. If the condition is satisfied, control circuitry 304 proceeds to line 608; if the condition is not satisfied, the algorithm proceeds to line 609 instead.

At line 608, control circuitry 304 executes a subroutine to select the portion of the background audio component as the audio asset. This means that the portion of the background audio component need not be replaced with an alternative audio asset because the portion of the background audio component is compliant with the user preference and the user preference attribute. In some embodiments, the selection may be achieved by processing circuitry 306 sending the appropriate signals to the processing circuitry. In some embodiments, control circuitry 304 stops the process and returns a message that the media asset need not be modified with a replacement audio asset. In some embodiments, control circuitry 304 proceeds through the code for replacing the portion of the background audio component if required.

At line 609, control circuitry 304 proceeds to line 610. At line 610, control circuitry 304 iterates through each audio asset available based on the user preference attribute. If only a single instance is available, the loop will only execute once. This loop may be implemented in multiple fashions depending on the choice of hardware and software language used to implement the process of FIG. 6; for example, this may be implemented as part of a “for” or “while” loop.

At line 611, control circuitry 304 retrieves the digital rights permissions for the audio asset from memory. The digital rights permissions may be stored in a database or as a separate file for the audio asset. The audio asset may be associated with digital rights permissions specifying whether the user may use the audio asset as background music in a customized media asset. In some embodiments, the digital rights permissions for the audio asset will be stored as part of a larger data structure or class, and the digital rights permissions required for the audio asset may be obtained through appropriate accessor methods. In some embodiments, the digital rights permissions required for the audio asset may be converted from a string or other non-numeric data type into a numeric data type by means of an appropriate hashing algorithm.

At line 612, control circuitry determines whether the digital rights permissions allow use of the audio asset as background music in a customized media asset. In some embodiments, control circuitry 304 may call a function to perform an analysis of the digital rights permissions. In some embodiments, the digital rights permissions for the audio asset may be encoded as a primitive data structure, and rather than using a temporary variable, the digital rights permissions for the audio asset may be directly used in the comparison at line 612. At line 613, control circuitry checks the result of the condition in line 612. If the condition is satisfied, control circuitry 304 proceeds to line 614; if the condition is not satisfied, control circuitry 304 proceeds to line 616 instead.

At line 614, control circuitry 304 executes a subroutine to select the audio asset to replace the portion of the background audio component of the media asset. This means that the portion of the background audio component is to be replaced with the alternative audio asset because the portion of the background audio component is not compliant with the user preference and the user preference attribute. In some embodiments, the selection may be achieved by processing circuitry 306 sending the appropriate signals to the processing circuitry. At line 615, control circuitry 304 breaks out of the loop because the condition in line 613 has already been satisfied.

At line 616, control circuitry 304 proceeds to line 617. At line 617, control circuitry 304 determines whether other audio assets are available based on the user preference attribute. For example, control circuitry 304 may call a function to determine whether other audio assets are available based on the user preference attribute. At line 618, if the function returns false (i.e., there are no instances remaining to be processed), control circuitry 304 proceeds to line 619. If other audio assets are available, control circuitry 304 proceeds to line 610 to continue the loop.

At line 619, control circuitry 304 executes a subroutine to select the portion of the background audio component as the audio asset. This means that no audio asset based on the user preference attribute is available to replace the portion of the background audio component. In some embodiments, the selection may be achieved by processing circuitry 306 sending the appropriate signals to the processing circuitry. In some embodiments, control circuitry 304 stops the process and returns a message that the media asset need not be modified with a replacement audio asset. In some embodiments, control circuitry 304 proceeds through the code for replacing the portion of the background audio component if required.

At line 621, control circuitry 304 runs a termination subroutine after the algorithm has performed its function. For example, in some embodiments control circuitry 304 may destruct variables, perform garbage collection, free memory or clear the cache of processing circuitry 306.

It will be evident to one skilled in the art that process 600 described by the pseudocode in FIG. 6 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some, embodiments break conditions may be placed after line 614 to speed operation, or the conditional statements may be replaced with a case-switch. In some embodiments, rather than iterating over all instances of available audio assets at line 610, in some embodiments the code may be rewritten so control circuitry 304 is instructed to evaluate multiple instances of available audio assets simultaneously on a plurality of processors or processor threads, lowering the number of iterations needed and potentially speeding up computation time.

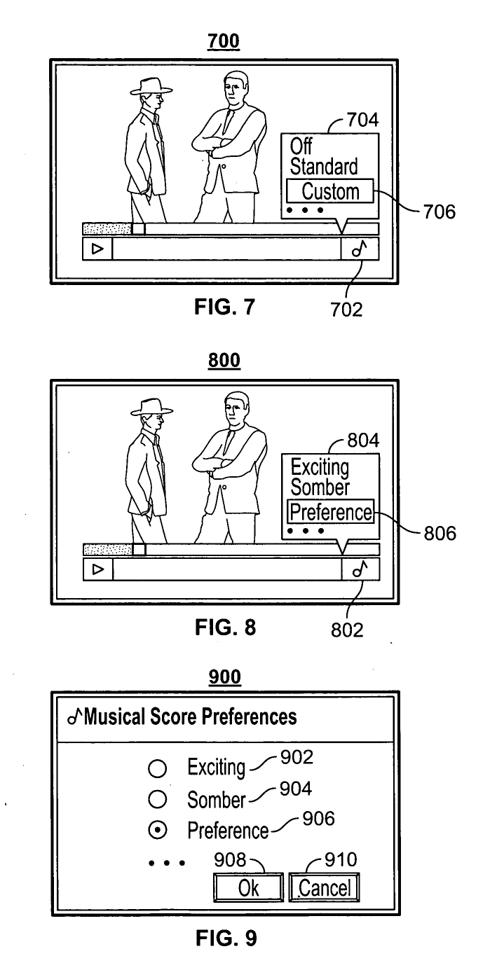

FIGS. 7-9 are diagrams of displays relating to customizing the musical score of a media asset in accordance with some embodiments of the disclosure. Unlike conventional systems, the interactive media guidance application implemented on control circuitry, e.g., control circuitry 304, allows a viewer to interact with the musical score or background music of a television program, a feature film, or another suitable media asset. For example, the viewer may select an alternative musical score for the media asset currently being displayed. In another example, the viewer may select to mute the background music for the media asset currently being displayed. In yet another example, the viewer may select to add background music where there is no background music in the media asset currently being displayed. In yet another example, the viewer may select alternative musical scores, add musical scores where there is no background music, or mute the background music for one or more portions of the media asset.

FIG. 7 is a diagram of display 700 relating to customizing the musical score of a media asset in accordance with some embodiments of the disclosure. The media asset includes associated metadata for a video component, a foreground audio component, and/or a background audio component. For example, the video component may represent the video frames of the media asset, the foreground audio component may represent the dialogue, special effects, and other suitable audio, and the background audio component may represent the musical score or background music.

In display 700, while the viewer is watching a television program, he or she can select option 702 to select an alternative music background for the current scene in the television program. On selecting option 702, the viewer is presented with options menu 704. If the user selects the OFF option, the interactive media guidance application turns off the background music for the current scene. If the user selects the STANDARD option, the interactive media guidance resumes or reselects the original background music intended for this scene of the television program, as required. If the user selects CUSTOM option 706, the user is presented another options menu.

FIG. 8 is a diagram of display 800 relating to customizing the musical score of a media asset in accordance with some embodiments of the disclosure. In display 800, the user is presented with options menu 804 after selecting option 802 and the CUSTOM option (option 706) from the previous options menu (options menu 704). If the user selects the EXCITING option, the interactive media guidance application selects another audio asset for the background music that the media asset provider provided for the EXCITING option. Similarly, if the user selects the SOMBER option, the interactive media guidance application selects another audio asset for the background music that the media asset provider provided for the SOMBER option.

In this illustrative embodiment, the viewer selects from different musical scores relating to different themes, such as exciting, somber, or another suitable theme. Each theme corresponds to a different metadata file that is provided for use when generating for display the media asset. In some embodiments, the media asset does not include a background audio component or related metadata and instead receives the background audio component and related metadata when the user selects a suitable theme for the media asset.

If the user selects PREFERENCE option 806, the interactive media guidance application selects an alternative musical score for the media asset currently being displayed based on a user preference. The interactive media guidance application identifies an attribute for the background audio component currently being used to generate the display of the media asset. For example, the interactive media guidance application may identify an attribute for the background audio component such as an artist, a track title, an album title, a tempo, a pitch, an intensity or loudness, or another suitable attribute.

The interactive media guidance application identifies a user preference attribute from the user preference. The user preference attribute is representative of the audiovisual history of the viewer. For example, the user preference attribute may include such an artist, a track title, an album title, a tempo, a pitch, an intensity or loudness, or another suitable attribute for audio and video media assets consumed by the viewer in the past. The interactive media guidance application compares the background audio attribute and the user preference attribute and may find that they do not match. This means that the viewer does not have a preference for the background music currently being played in the media asset.

For example, the user preference attribute may indicate the viewer has a preference for tempo in a given range. The background music attribute may indicate tempo in a range outside other of the viewer's preferred range. In this example, the interactive media guidance application determines that the current portion of the background audio component of the media asset needs to be replaced with another audio asset suitable for the viewer. The suitable audio asset is selected based on the user preference attribute. The interactive media guidance application may trim a play time of the selected audio asset to match the play time of the portion of the background audio component being replaced.

FIG. 9 is a diagram of display 900 relating to customizing the musical score of a media asset in accordance with some embodiments of the disclosure. In this illustrative embodiment, the viewer may receive a pop-up to select from different musical scores relating to different themes, such as exciting, somber, or another suitable theme. Each theme corresponds to a different metadata file that is provided for use when generating for display the media asset. If the user selects EXCITING option 902, the interactive media′ guidance application selects another metadata file for the background music that the media asset provider provided for the EXCITING option. Similarly, if the user selects the SOMBER option, the interactive media guidance application selects another metadata file for the background music that the media asset provider provided for the SOMBER option. If the user selects PREFERENCE option 906, the interactive media guidance application selects an alternative metadata file for the media asset based on a user preference. The interactive media guidance application follows a process similar to that described with respect to FIG. 8 above. The viewer may select option 908 to confirm his or her selection or select option 910 to cancel the selection and return to the media asset.

In some embodiments, the interactive media guidance application replaces the background audio component of a media asset with the background audio component of another media asset. For example, the interactive media guidance application may substitute the musical score of a movie, such as “Transformers: Age of Extinction,” with the musical score of another related movie, such as “Inception.” These musical scores are related in this example because they are composed by the same person and the movie studio is licensed to use both musical scores. In some embodiments, the viewer receives an option to select an alternative musical score when selecting a media asset for display.

For example, the viewer may receive a pop-up to select the musical score from “Inception” when selecting to view the movie “Transformers: Age of Extinction.” The selection of the musical score from “Inception” may provide an alterative metadata file that may be used to generate for display the media asset. The metadata file may include references to scenes or blocks of frames and the background music that should be substituted instead of the original background music provided for the media asset. For example, the metadata file may include SMPTE timecodes. The SMPTE timecodes are a form of media metadata and can be used to label individual frames of video with a time code to synchronize music.

In some embodiments, the interactive media guidance application selects an alternative musical score from the viewer's personal music library. Since the viewer has purchased the music in his or her library, using one or more audio assets as background music may be an acceptable use for the purchased audio assets. The audio assets may be associated with digital rights permissions specifying whether the viewer may use them as background music in a customized media asset. The interactive media guidance application may only use audio assets from the viewer's personal music library if the digital rights permissions for the audio assets allow use as background music for the viewer's customized media asset.

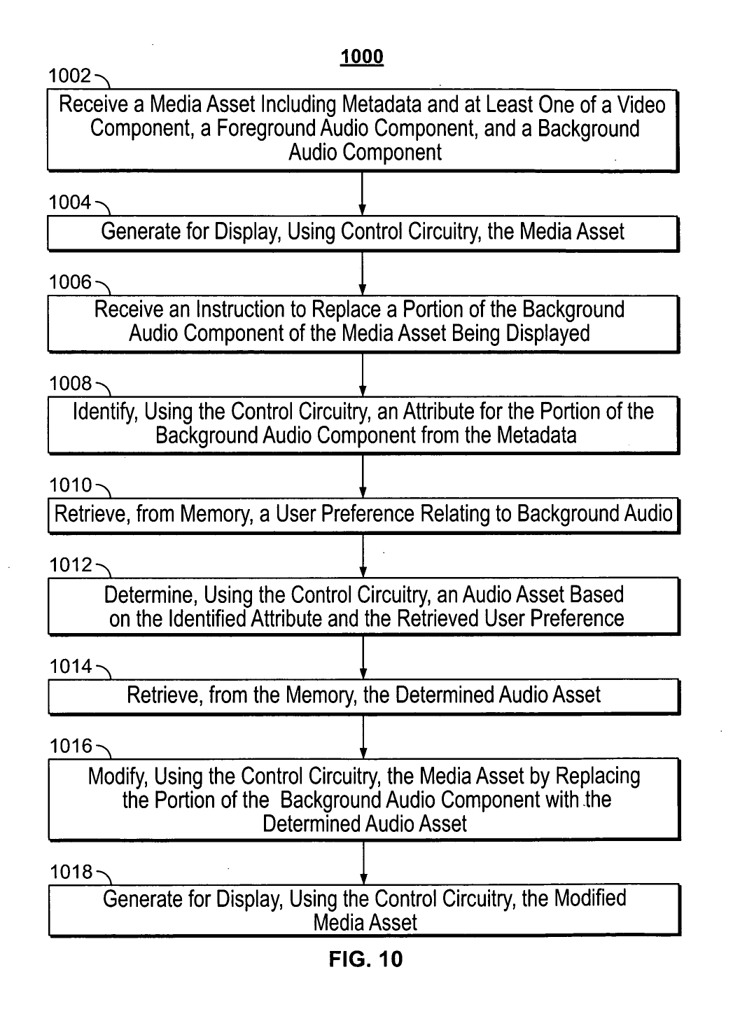

FIG. 10 is a flowchart of illustrative process 1000 for customizing the musical score of a media asset in accordance with some embodiments of the disclosure. It should be noted that process 1000 or any step thereof could be performed on, or provided by, any of the devices shown in FIGS. 3-4. For example, process 1000 may be executed by control circuitry 304 (FIG. 3) as instructed by an interactive media guidance application implemented on user equipment 402, 404, and/or 406 (FIG. 4). In addition, one or more steps of process 1000 may be incorporated into or combined with one or more steps of any other process or embodiment (e.g., FIGS. 5-6).

At step 1002, control circuitry 304 receives a media asset including metadata and at least one of a video component, a foreground audio component, and a background audio component. In some embodiments, the metadata is received separately from the media asset. In some embodiments, the metadata comprises separate metadata files for each of the video component, the foreground audio component, and the background audio component. At step 1004, control circuitry 304 generates for display the media asset.

At step 1006, control circuitry 304 receives an instruction to replace a portion of the background audio component of the media asset being displayed. In some embodiments, the instruction to replace the portion of the background audio component of the media asset being displayed is received from a user. In some embodiments, the instruction to replace the portion of the background audio component of the media asset being displayed is automatically generated based on the user preference relating to background audio. For example, the user or control circuitry 304 may select an alternative musical score for the media asset currently being displayed. In another example, the user or control circuitry 304 may select to mute the background music for the media asset currently being displayed. In yet another example, the user or control circuitry 304 may select to add background music where there is no background music in the media asset currently being displayed.

At step 1008, control circuitry 304 identifies an attribute for the portion of the background audio component from the metadata. For example, control circuitry 304 may identify an attribute for the background audio component such as an artist, a track title, an album title, a tempo, a pitch, an intensity or loudness, or another suitable attribute. At step 1010, control circuitry 304 retrieves a user preference relating to background audio from a memory. Control circuitry 304 identifies a user preference attribute from the user preference. In some embodiments, the user preference relating to the background audio comprises a user preference attribute based on an audiovisual history of a user. For example, the user preference attribute may include such an artist, a track title, an album title, a tempo, a pitch, an intensity or loudness, or another suitable attribute for audio and video media assets consumed by the user in the past.

At step 1012, control circuitry 304 determines an audio asset based on the identified attribute and the retrieved user preference. For example, control circuitry 304 may compare the background audio attribute and the user preference attribute and may find that they do not match. This means that the user does not have a preference for the background music currently being played in the media asset. In this example, control circuitry 304 determines that the current portion of the background audio component of the media asset needs to be replaced with another audio asset suitable for the user. The suitable audio asset may be selected based on the user preference attribute.

At step 1014, control circuitry 304 retrieves the determined audio asset from the memory. At step 1016, control circuitry 304 modifies the media asset by replacing the portion of the background audio component of the media asset with the determined audio asset. In some embodiments, control circuitry 304 modifying the media asset by replacing the portion of the background audio component of the media asset with the determined audio asset further includes trimming a play time of the determined audio asset to substantially match a play time of the portion of the background audio component. At step 1018, control circuitry 304 generates for display the modified media asset.

In some embodiments, control circuitry 304 determining the audio asset based on the identified attribute and the retrieved user preference includes control circuitry 304 determining whether the identified attribute corresponds to the user preference attribute. For example, the user preference attribute may indicate the user has a preference for tempo in a given range. The background music attribute may indicate tempo in a range outside other of the user's preferred range. In response to determining that the identified attribute does not correspond to the user preference attribute, control circuitry 304 determines the audio asset based on the user preference attribute. In some embodiments, in response to determining that the identified attribute corresponds to the user preference attribute, control circuitry 304 selects the portion of the background audio component.

In some embodiments, control circuitry 304 determining the audio asset based on the identified attribute and the retrieved user preference includes control circuitry 304 identifying the audio asset relating to the identified attribute and the retrieved user preference. Control circuitry 304 retrieves digital rights permissions for the audio asset from the memory. Control circuitry 304 selects the audio asset if the digital rights permissions allow use as background music. For example, control circuitry 304 may only use audio assets if the digital rights permissions for the audio assets allow use as background music for the user's customized media asset. In some embodiments, the determined audio asset is retrieved from a music library for a user. Since the user has purchased the music in his or her library, using one or more audio assets as background music may be an acceptable use for the purchased audio assets.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 10.

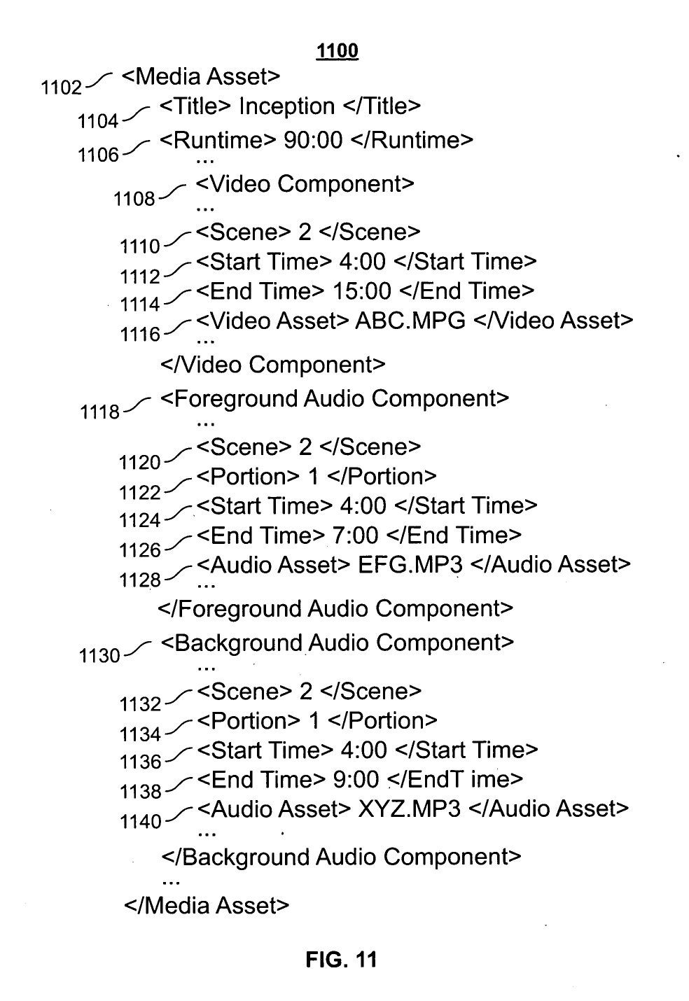

FIG. 11 is illustrative metadata for a media asset in accordance with some embodiments of the disclosure. The interactive media guidance application receives a media asset including metadata and at least one of a video component, a foreground audio component, and a background audio component. For example, the video component may represent the video frames of the media asset, the foreground audio component may represent the dialogue, special effects, and other suitable audio, and the background audio component may represent the musical score or background music. In some embodiments, the metadata is received separately from the media asset. In some embodiments, the metadata comprises separate metadata files for each of the video component, the foreground audio component, and the background audio component.

In some embodiments, metadata 1100 is received by control circuitry 304 as described with reference to step 1002 in FIG. 10. Metadata 1100 may be retrieved from a media asset or retrieved from a remote database or a local memory if the metadata is stored separately from the media asset. Metadata 1100 may be included in a database, kept as a separate file, or stored and/or retrieved in any other suitable manner. Metadata 1100 includes a plurality of fields.

In the illustrated embodiment, metadata 1100 includes fields 1102-1140. Field 1102 indicates the beginning of metadata 1100 and a corresponding field at the end indicates the end of the metadata 1100. Field 1104 indicates that the title of the media asset related to metadata 1100 is “INCEPTION.” Field 1106 indicates that the runtime of the media asset related to metadata 1100 is “90:00” or 90 minutes.

Field 1108 indicates the beginning of video component metadata and a corresponding field at the end indicates the end of the video component metadata. The video component metadata may include information for a plurality of scenes and associated times. Field 1110 indicates that the following information is for scene “2.” Field 1112 indicates that the start time of the associated scene is “4:00” or four minutes into the media asset. Field 1114 indicates that the end time of the associated scene is “15:00” or 15 minutes into the media asset. Field 1116 indicates that the video asset of the associated scene is “ABC.MPG,” i.e., the scene is stored in the named file.

Field 1118 indicates the beginning of foreground audio component metadata and a corresponding field at the end indicates the end of the foreground audio component metadata. The foreground audio component metadata may include information for a plurality of scenes. Field 1120 indicates that the following information is for scene “2.” The foreground audio component metadata may include information for a plurality of portions of scenes and associated times. Field 1122 indicates that the following information is for portion “1” of scene “2.” Field 1124 indicates that the start time of the associated portion of the scene is “4:00” or four minutes into the media asset. Field 1126 indicates that the end time of the associated portion of the scene is “7:00” or seven minutes into the media asset. Field 1128 indicates that the foreground audio asset of the associated portion of the scene is “EFG.MP3,” i.e., the foreground audio for the portion of the scene is stored in the named file.

Field 1130 indicates the beginning of background audio component metadata and a corresponding field at the end indicates the end of the background audio component metadata. The background audio component metadata may include information for a plurality of scenes. Field 1132 indicates that the following information is for scene “2.” The background audio component metadata may include information for a plurality of portions of scenes and associated times. Field 1134 indicates that the following information is for portion “1” of scene “2.” Field 1136 indicates that the start time of the associated portion of the scene is “4:00” or four minutes into the media asset. Field 1138 indicates that the end time of the associated portion of the scene is “9:00” or nine minutes into the media asset. Field 1140 indicates that the background audio asset of the associated portion of the scene is “XYZ.MP3,” i.e., the background audio for the portion of the scene is stored in the named file.

For example, the viewer may select alternative background music, add background music where there is no background music, or mute the background music for one or more portions of the media asset. The interactive media guidance application may identify an attribute for the background audio component currently being used to generate the display of the media asset. Information regarding the portion of the background audio component may be determined using the associated metadata. For example, the background audio component for scene “2,” portion “1,” with start time “4:00,” and end time “9:00,” is stored in audio asset “XYZ.MP3.” The interactive media guidance application may identify an attribute for the background audio component from the audio asset, “XYZ.MP3,” such as an artist, a track title, an album title, a tempo, a pitch, an intensity or loudness, or another suitable attribute.

For example, the user preference attribute may indicate the viewer has a preference for tempo in a given range. The tempo attribute for the current portion of the background audio component, “XYZ.MP3,” may indicate tempo in a range outside other of the viewer's preferred range. The interactive media guidance application may determine that the current portion of the background audio component, “XYZ.MP3,” of the media asset needs to be replaced with another audio asset suitable for the viewer.

While the above-described embodiments are presented in the context of customizing the background audio component of the media asset, they may be equally and/or appropriately applicable to customizing the video component, the foreground audio component, or any other suitable component of the media asset. For example, the viewer may customize the foreground audio component of the media asset to replace violent special effects sounds with other appropriate sounds. In another example, the viewer may customize the video component to replace violent scenes with other appropriate scenes.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for customizing a musical score of a media asset, comprising:
receiving a media asset including metadata and at least one of a video component, a foreground audio component, and a background audio component;
generating for display, using control circuitry, the media asset;
receiving an instruction to replace a portion of the background audio component of the media asset being displayed;
identifying, using the control circuitry, an attribute for the portion of the background audio component from the metadata;
retrieving, from a memory, a user preference relating to background audio;
determining, using the control circuitry, an audio asset based on the identified attribute and the retrieved user preference;
retrieving, from the memory, the determined audio asset;
modifying, using the control circuitry, the media asset by replacing the portion of the background audio component of the media asset with the determined audio asset; and
generating for display, using the control circuitry, the modified media asset.

2. The method of claim 1, wherein the instruction to replace the portion of the background audio component of the media asset being displayed is received from a user.

3. The method of claim 1, wherein the instruction to replace the portion of the background audio component of the media asset being displayed is automatically generated based on the user preference relating to background audio.

4. The method of claim 1, wherein the attribute comprises one or more of an artist, a track title, an album title, a tempo, a pitch, and an intensity.

5. The method of claim 1, wherein the user preference relating to the background audio comprises a user preference attribute based on an audiovisual history of a user.

6. The method of claim 5, wherein determining, using the control circuitry, the audio asset based on the identified attribute and the retrieved user preference comprises:
determining, using the control circuitry, whether the identified attribute corresponds to the user preference attribute; and
in response to determining that the identified attribute does not correspond to the user preference attribute, determining, using the control circuitry, the audio asset based on the user preference attribute.

7. The method of claim 6, further comprising:
in response to determining that the identified attribute corresponds to the user preference attribute, selecting, using the control circuitry, the portion of the background audio component.

8. The method of claim 1, wherein determining, using the control circuitry, the audio asset based on the identified attribute and the retrieved user preference comprises:
identifying, using the control circuitry, the audio asset relating to the identified attribute and the retrieved user preference;
retrieving, from the memory, digital rights permissions for the audio asset; and
selecting, using the control circuitry, the audio asset if the digital rights permissions allow use as background music.

9. The method of claim 1, wherein the determined audio asset is retrieved from a music library for a user.

10. The method of claim 1, wherein modifying, using the control circuitry, the media asset by replacing the portion of the background audio component of the media asset with the determined audio asset further comprises:
trimming, using the control circuitry, a play time of the determined audio asset to substantially match a play time of the portion of the background audio component.

11. A system for customizing a musical score of a media asset, comprising:
a memory configured to store a user preference relating to background audio and an audio asset relating to the user preference;
control circuitry configured to:
receive a media asset including metadata and at least one of a video component, a foreground audio component, and a background audio component;
generate for display the media asset;
receive an instruction to replace a portion of the background audio component of the media asset being displayed;
identify an attribute for the portion of the background audio component from the metadata;
retrieve, from the memory, the user preference relating to background audio;
determine the audio asset based on the identified attribute and the retrieved user preference;
retrieve, from the memory, the determined audio asset;
modify the media asset by replacing the portion of the background audio component of the media asset with the determined audio asset; and
generate for display the modified media asset.

12. The system of claim 11, wherein the instruction to replace the portion of the background audio component of the media asset being displayed is received from a user.

13. The system of claim 11, wherein the instruction to replace the portion of the background audio component of the media asset being displayed is automatically generated based on the user preference relating to background audio.

14. The system of claim 11, wherein the attribute comprises one or more of an artist, a track title, an album title, a tempo, a pitch, and an intensity.

15. The system of claim 11, wherein the user preference relating to the background audio comprises a user preference attribute based on an audiovisual history of a user.

16. The system of claim 15, wherein the control circuitry configured to determine the audio asset based on the identified attribute and the retrieved user preference comprises control circuitry configured to:
determine whether the identified attribute corresponds to the user preference attribute; and
in response to determining that the identified attribute does not correspond to the user preference attribute, determine the audio asset based on the user preference attribute.

17. The system of claim 16, the control circuitry further comprising control circuitry configured to:
in response to determining that the identified attribute corresponds to the user preference attribute, select the portion of the background audio component.

18. The system of claim 11, wherein the control circuitry configured to determine the audio asset based on the identified attribute and the retrieved user preference comprises control circuitry configured to:
identify the audio asset relating to the identified attribute and the retrieved user preference;
retrieve, from the memory, digital rights permissions for the audio asset; and
select the audio asset if the digital rights permissions allow use as background music.

19. The system of claim 11, wherein the determined audio asset is retrieved from a music library for a user.

20. The system of claim 11, wherein the control circuitry configured to modify the media asset by replacing the portion of the background audio component of the media asset with the determined audio asset further comprises control circuitry configured to:
trim a play time of the determined audio asset to substantially match a play time of the portion of the background audio component.

21-50. (canceled)
